(19) United States
(12) Patent Application Publication
(10) Pub. No.: US 2025/0231858 A1
(43) Pub. Date: Jul. 17, 2025

(54) DEVICE CONFIGURATION ADJUSTMENT

(71) Applicant: Tencent Technology (Shenzhen) Company Limited, Shenzhen (CN)

(72) Inventors: Yaxi JIN, Shenzhen (CN); Jun DENG, Shenzhen (CN); Minghong CHENG, Shenzhen (CN); Xiaohui ZHENG, Shenzhen (CN); Guangjin HUO, Shenzhen (CN)

(73) Assignee: Tencent Technology (Shenzhen) Company Limited, Shenzhen, GD (CN)

(21) Appl. No.: 19/170,043

(22) Filed: Apr. 3, 2025

Related U.S. Application Data
(63) Continuation of application No. PCT/CN2024/078235, filed on Feb. 23, 2024.

(30) Foreign Application Priority Data
Mar. 10, 2023 (CN) 202310278589.0

(51) Int. Cl. G06F 11/34

(52) U.S. Cl. CPC G06F 11/3452; G06F 11/3428

(57) ABSTRACT

In a method for device configuration adjustment, a first hardware metric of a device at a first moment that the device executes a virtual event is obtained. An evaluated performance value is determined based on the first hardware metric and process data. A first comparison result is obtained based on comparing a first preset threshold of the device with the evaluated performance value. A second hardware metric of the device at a second moment is obtained based on the first comparison result. A second comparison result is obtained based on comparing execution results of the virtual event. A second preset threshold is obtained based on adjusting the first preset threshold with the second comparison result. The device is adjusted at the second moment based on the second preset threshold and the second hardware metric.

### RELATED APPLICATIONS

The present application is a continuation of International Application No. PCT/CN2024/078235, filed on Feb. 23, 2024, which claims priority to Chinese Patent Application No. 202310278589.0, filed on Mar. 10, 2023. The entire disclosures of the prior applications are hereby incorporated by reference.

### FIELD OF THE TECHNOLOGY

This is disclosure relates to the field of computers including to a device configuration adjustment method and apparatus, a storage medium, and an electronic device.

### BACKGROUND OF THE DISCLOSURE

In a device configuration adjustment scenario, device configuration is usually adjusted by using a neural network algorithm. Accuracy of the neural network algorithm relies on a large amount of computation. However, deployment of a large amount of computation to a device may cause additional performance overhead, and consequently, efficiency of device configuration adjustment is reduced. Conversely, a small amount of computation cannot ensure accuracy of the device configuration adjustment. Therefore, it is challenging to achieve high efficiency and high accuracy of the device configuration adjustment at the same time.

### SUMMARY

Embodiments of this disclosure include a method and an apparatus for device configuration adjustment, an electronic device, a non-transitory computer-readable storage medium, and a computer program product.

Technical solutions of embodiments of this disclosure may be implemented as follows.

An embodiment of this disclosure provides a method for device configuration adjustment. In the method, a first hardware metric of a device at a first moment that the device executes a virtual event is obtained. Process data affecting performance of the device at the first moment is obtained. An evaluated performance value is determined based on the first hardware metric and the process data. A first comparison result is obtained based on comparing a first preset threshold of the device with the evaluated performance value. A second hardware metric of the device at a second moment is obtained based on the first comparison result. A second comparison result is obtained based on comparing a first execution result of the virtual event at the first moment with a second execution result of the virtual event at the second moment. A second preset threshold is obtained based on adjusting the first preset threshold with the second comparison result. The device is adjusted at the second moment based on the second preset threshold and the second hardware metric.

An embodiment of this disclosure provides an apparatus for device configuration adjustment. The apparatus includes processing circuitry that is configured to obtain a first hardware metric of a device at a first moment that the device executes a virtual event, obtain process data affecting performance of the device at the first moment, determine, based on the first hardware metric and the process data, an evaluated performance value at the first moment that indicates a degree of matching between the performance of the device at the first moment and the virtual event, obtain a first comparison result based on comparing a first preset threshold of the device with the evaluated performance value, obtain a second hardware metric of the device at a second moment based on the first comparison result, obtain a second comparison result based on comparing a first execution result of the virtual event at the first moment with a second execution result of the virtual event at the second moment, obtain a second preset threshold of the device at the second moment based on adjusting the first preset threshold with the second comparison result, and adjust the device at the second moment based on the second preset threshold and the second hardware metric.

An embodiment of this disclosure provides a device, including a memory and a processor. The memory is configured to store executable instructions. The processor is configured to implement, when executing the executable instructions stored in the memory, the method for device configuration adjustment provided in embodiments of this disclosure.

An embodiment of this disclosure provides a non-transitory computer-readable storage medium, storing instructions which when executed by a processor cause the processor to perform the method for device configuration adjustment provided in embodiments of this disclosure.

An embodiment of this disclosure provides a computer program product, including a computer program or computer-executable instructions. When the computer program or the computer-executable instructions are executed by a processor, the method for device configuration adjustment provided in embodiments of this disclosure is implemented.

### BRIEF DESCRIPTION OF THE DRAWINGS

FIG. 1 is a schematic diagram of an application environment of a device configuration adjustment method according to an embodiment of this disclosure.

FIG. 2 is a schematic flowchart of a device configuration adjustment method according to an embodiment of this disclosure.

FIG. 3 is a schematic diagram of a device configuration adjustment method according to an embodiment of this disclosure.

FIG. 4 is a schematic diagram of another device configuration adjustment method according to an embodiment of this disclosure.

FIG. 5 is a schematic diagram of another device configuration adjustment method according to an embodiment of this disclosure.

FIG. 6 is a schematic diagram of another device configuration adjustment method according to an embodiment of this disclosure.

FIG. 7 is a schematic diagram of another device configuration adjustment method according to an embodiment of this disclosure.

FIG. 8 is a schematic diagram of another device configuration adjustment method according to an embodiment of this disclosure.

FIG. 9 is a schematic diagram of another device configuration adjustment method according to an embodiment of this disclosure.

FIG. 10 is a schematic diagram of another device configuration adjustment method according to an embodiment of this disclosure.

FIG. 11 is a schematic diagram of another device configuration adjustment method according to an embodiment of this disclosure.

FIG. 12 is a schematic diagram of a device configuration adjustment apparatus according to an embodiment of this disclosure.

FIG. 13 is a schematic diagram of a structure of an electronic device according to an embodiment of this disclosure.

### DESCRIPTION OF EMBODIMENTS

To make the objectives, technical solutions, and advantages of this disclosure clearer, the following describes this disclosure in further detail with reference to the accompanying drawings. The described embodiments are not to be considered as a limitation on this disclosure. Other embodiments are within the scope of this disclosure.

In the specification, claims, and accompanying drawings of this disclosure, the terms “first”, “second”, and the like are intended to distinguish similar objects but do not necessarily indicate a specific order or sequence. Such used data is changeable under appropriate conditions, so that embodiments of this disclosure described here can be implemented in an order other than those illustrated or described here. Moreover, the terms “include”, “contain” and any other variants mean to cover the non-exclusive inclusion, for example, a process, method, system, product, or device that includes a list of operations or units is not necessarily limited to those expressly listed operations or units, but may include other operations or units not expressly listed or inherent to such a process, method, system, product, or device.

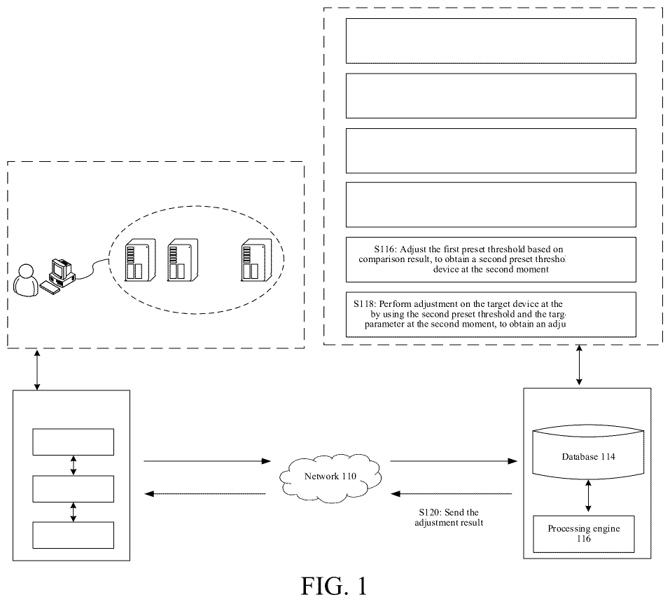

According to an aspect of embodiments of this disclosure, a device configuration adjustment method is provided. In some embodiments, the device configuration adjustment method may be applied to, but is not limited to, an implementation environment shown in FIG. 1. The implementation environment may include, but is not limited to, a user device 102 and a server 112. The user device 102 may include, but is not limited to, a display 104, a processor 106, and a memory 108. The server 112 includes a database 114 and a processing engine 116.

Specific processes may include the following operations.
Operation S102: Obtain a target hardware parameter of a user device 102 (target device) at a first moment and target process data of a virtual event at the first moment.
Operation S104 and operation S106: Send the target hardware parameter and the target process data to the server 112 via a network 110.
Operation S108 to operation S118: The server 112 determines an evaluated performance value of the target device at the first moment based on the target hardware parameter at the first moment and the target process data at the first moment by using the processing engine 116; compares, when a first preset threshold of the target device at the first moment is obtained by using the database 114, the first preset threshold with the evaluated performance value at the first moment to obtain a first comparison result; updates the target hardware parameter of the target device at the first moment based on the first comparison result, to obtain a target hardware parameter of the target device at a second moment; compares, when a first execution result of the virtual event at the first moment and a second execution result of the virtual event at the second moment are obtained by using the database 114, the first execution result with the second execution result to obtain a second comparison result; and further adjusts the first preset threshold based on the second comparison result by using the processing engine 116, to obtain a second preset threshold of the target device at the second moment, and adjusts the target device at the second moment by using the second preset threshold and the target hardware parameter at the second moment, to obtain an adjustment result. The first preset threshold is a threshold for the target device to adjust a configuration parameter at the first moment, may indicate how to adjust the configuration parameter of the target device at the first moment, and includes a preset downgrading threshold and a preset upgrading threshold.
Operation S120 and operation S122: Send the adjustment result to the user device 102 via the network 110, and the user device 102 displays the adjustment result on the display 104 by using the processor 106, and stores the adjustment result in the memory 108.

In addition to the example shown in FIG. 1, the foregoing operations may be independently completed by the user device or the server, or may be cooperatively completed by the user device and the server. For example, the user device 102 performs the foregoing operations of determining the evaluated performance value of the target device at the first moment, comparing the first preset threshold with the evaluated performance value at the first moment, performing adjustment on the target device at the first moment based on the first comparison result, comparing the first execution result with the second execution result, adjusting the first preset threshold based on the second comparison result, and performing adjustment on the target device at the second moment by using the second preset threshold and the target hardware parameter at the second moment, to relief processing pressure of the server 112. The user device 102 includes, but is not limited to, a handheld device (such as a mobile phone), a laptop computer, a tablet computer, a desktop computer, an on-board device, a smart television, and the like. The specific implementations of the user device 102 are not limited in this disclosure. The server 112 may be an independent server or a server cluster that includes a plurality of servers, or may be a cloud server.

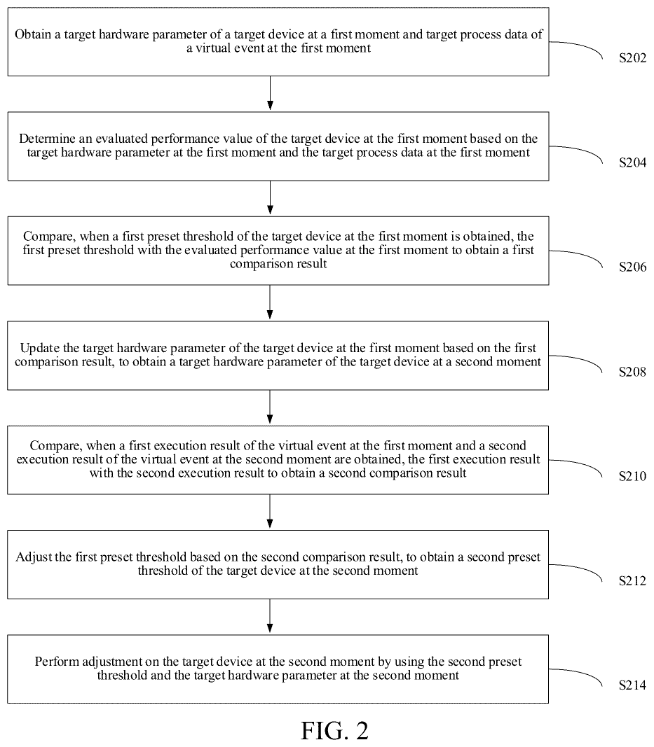

In some embodiments, as shown in FIG. 2, the device configuration adjustment method may be performed by an electronic device, for example, the user device or the server shown in FIG. 1. Specific operations include:
S202: Obtain a target hardware parameter of a target device at a first moment and target process data of a virtual event at the first moment, the target device being an execution device participating in the virtual event, the target hardware parameter being a hardware usage parameter when the target device participates in the virtual event, and the target process data being process data affecting performance of the target device during execution of the virtual event. In an example, a first hardware metric of a device at a first moment that the device executes a virtual event is obtained and process data affecting performance of the device at the first moment is obtained.
S204: Determine an evaluated performance value of the target device at the first moment based on the target hardware parameter at the first moment and the target process data at the first moment, the evaluated performance value being configured for evaluating a degree of matching between the performance of the target device and the virtual event. In an example, based on the first hardware metric and the process data, an evaluated performance value at the first moment that indicates a degree of matching between the performance of the device at the first moment and the virtual event is determined.
S206: Compare, when a first preset threshold of the target device at the first moment is obtained, the first preset threshold with the evaluated performance value at the first moment to obtain a first comparison result. In an example, a first comparison result is obtained based on comparing a first preset threshold of the device with the evaluated performance value.
S208: Update the target hardware parameter of the target device at the first moment based on the first comparison result, to obtain a target hardware parameter of the target device at a second moment, the second moment being a next moment following the first moment. In an example, a second hardware metric of the device at a second moment is obtained based on the first comparison result.
S210: Compare, when a first execution result of the virtual event at the first moment and a second execution result of the virtual event at the second moment are obtained, the first execution result with the second execution result to obtain a second comparison result. In an example, a second comparison result is obtained based on comparing a first execution result of the virtual event at the first moment with a second execution result of the virtual event at the second moment.
S212: Adjust the first preset threshold based on the second comparison result, to obtain a second preset threshold of the target device at the second moment. In an example, a second preset threshold of the device at the second moment is obtained based on adjusting the first preset threshold with the second comparison result.
S214: Perform adjustment on the target device at the second moment by using the second preset threshold and the target hardware parameter at the second moment. In an example, the device at the second moment is adjusted based on the second preset threshold and the second hardware metric.

In some embodiments of this disclosure, the foregoing device configuration adjustment method may be, but is not limited to, applied to an adjustment scenario of a graphics processing unit (GPU for short) or a central processing unit (CPU for short). The CPU is used as an example for description. Specifically, in a process in which a target device participates in execution of a virtual event, the CPU needs to be used according to a percentage. However, excessive CPU utilization may reduce performance of the target device, to affect execution quality of the virtual event. Therefore, adaptive adjustment needs to be performed on device configuration, to balance device performance and the execution quality of the virtual event.

In some embodiments of this disclosure, the target hardware parameter may be, but is not limited to, a hardware usage parameter when the target device participates in the virtual event, for example, CPU utilization, GPU utilization, CPU temperature, GPU temperature, and memory consumption when the target device participates in the virtual event.

In some embodiments of this disclosure, the virtual event may be, but is not limited to, an execution event run on the target device or a server, for example, a virtual game, a virtual task, a virtual match, or a virtual resource. The target device directly participates in or indirectly participates in the virtual event. For example, the target device controls a virtual character to participate in execution of the virtual event.

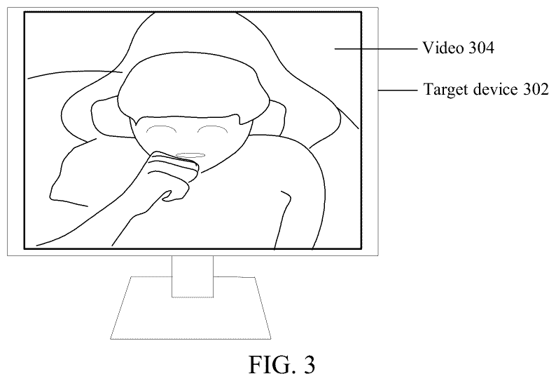

Further, for example, as shown in FIG. 3, the virtual event may be, but is not limited to, a video 304 played on a target device 302. Adaptive adjustment is performed on configuration of the target device 302 based on a playback status of the video 304, until the configuration of the target device 302 matches the playback status of the video 304.

In some embodiments of this disclosure, the target process data is process data affecting the performance of the target device during execution of the virtual event. For example, when a user of the target device watches a video, the performance of the target device may be affected by selecting a relatively high video image quality, and further, process data corresponding to the video image quality may be understood as the target process data. For another example, when watching livestreaming, a user of the target device enables a gift special effect, or there are a large quantity of watchers in a livestreaming room. These all affect the performance of the target device, so that process data corresponding to the gift special effect or the quantity of the watchers may be understood as the target process data. For another example, when a user plays a multiplayer battle game, a plurality of special effects, virtual characters, or the like appear in a process of the game, affecting the performance of the target device, so that process data corresponding to a quantity of the special effects or the virtual characters may be understood as the target process data.

In some embodiments of this disclosure, the evaluated performance value is configured for evaluating a degree of matching between the performance of the target device and the virtual event. For example, the evaluated performance value at the first moment is configured for evaluating a degree of matching between the performance of the target device at the first moment and the virtual event. A highest degree of matching may represent, but is not limited to, an execution result of the virtual event at the first moment, and configuration of the target device at the first moment may be used to a greatest extent.

In some embodiments of this disclosure, the first moment and the second moment may represent, but are not limited to, that a device configuration adjustment process is an iterative process, and each round in the iterative process corresponds to a moment. For example, device configuration adjustment at the first moment corresponds to a first round of device configuration adjustment in the iterative process, and device configuration adjustment at the second moment corresponds to a second round of device configuration adjustment in the iterative process. The target device may be iterated a plurality of times until a convergence condition is satisfied, for example, the evaluated performance value is greater than or equal to a preset evaluation threshold.

In addition, when the first moment is an initial moment (first iteration), only configuration of the target device may be adjusted, and a preset threshold participating in comparison is not adjusted, but this is not limited thereto. When the first moment is a non-initial moment, the configuration of the target device may be adjusted, and the preset threshold participating in the comparison may be adjusted.

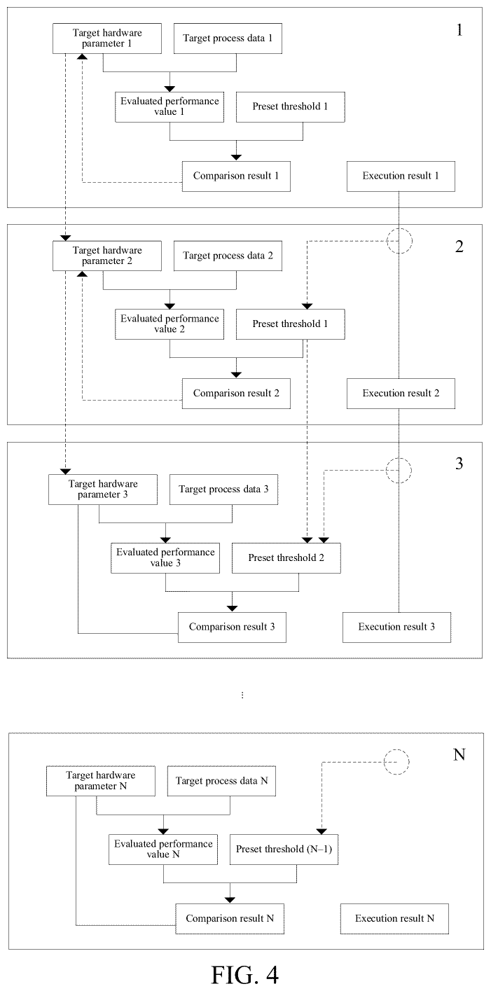

Further, as shown in FIG. 4, at a first iteration (moment 1), an evaluated performance value 1 may be obtained by using a target hardware parameter 1 and target process data 1, and then the evaluated performance value 1 may be compared with a preset threshold 1 to obtain a comparison result 1. Further, the target hardware parameter 1 may be adjusted based on the comparison result 1 to obtain a target hardware parameter 2.

Then, at a second iteration (moment 2), an evaluated performance value 2 may be obtained by using the target hardware parameter 2 and target process data 2, and then the evaluated performance value 2 may be compared with the preset threshold 1 to obtain a comparison result 2. Further, the target hardware parameter 2 may be adjusted based on the comparison result 2 to obtain a target hardware parameter 3. In addition, an execution result 1 may be compared with an execution result 2, and the preset threshold 1 may be adjusted based on a comparison result, to obtain a preset threshold 2. The preset threshold 2 may be configured for device configuration adjustment at a next round (moment 3).

Then, at a third iteration (moment 3), an evaluated performance value 3 may be obtained by using the target hardware parameter 3 and target process data 3, and then the evaluated performance value 3 may be compared with the preset threshold 2 to obtain a comparison result 3. Further, the target hardware parameter 3 may be adjusted based on the comparison result 3 to obtain a target hardware parameter 4. In addition, the execution result 2 may be compared with an execution result 3, and the preset threshold 2 may be adjusted based on a comparison result, to obtain a preset threshold 3. The preset threshold 3 may be configured for device configuration adjustment at a next round (moment 4), until a convergence condition is satisfied, for example, at an N^{th} iteration (moment N).

In some embodiments of this disclosure, an execution result of the virtual event includes an objective execution result and a subjective execution result. The virtual event may correspond to, but is not limited to, different objective execution results at different moments, such as a frame rate, a delay, a frame drop, a lag, and a refresh rate. In addition, to improve accuracy of the execution result, the subjective execution result may be further obtained, but this is not limited thereto. Each user participating in the virtual event submits subjective comment information, for example, the user submits information such as “feel lagging” or “think that a frame drop is serve”. The information may be then used as the subjective execution result.

In some embodiments of this disclosure, the second comparison result is configured for representing an execution result error between two different moments, so that a device configuration adjustment trend may be determined based on the second comparison result. If the execution result error is large and is a positive error, the device configuration adjustment tends to be proper. Conversely, if the execution result error is small or is a negative error, the device configuration adjustment tends to be improper, and an adjustment manner towards being proper needs to be re-formulated.

Device performance at a current moment is determined by evaluating the performance of the target device by using a hardware parameter and process data, and positive configuration adjustment is performed on the target device through comparison of the performance and a preset threshold. In addition, to further improve accuracy of device configuration adjustment, error comparison is further performed on event execution results at different moments, to adjust the preset threshold configured for comparison, so that the device configuration adjustment is efficiently completed, and the accuracy of the device configuration adjustment is further improved, thereby achieving a technical effect of achieving high efficiency and high accuracy of the device configuration adjustment at the same time.

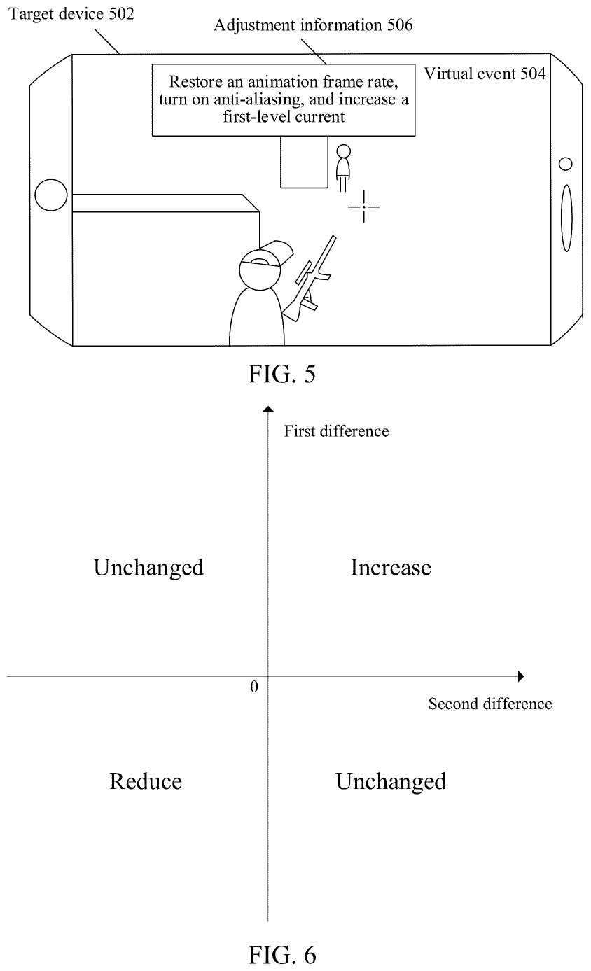

For further example, as shown in FIG. 5, a target hardware parameter of a target device 502 at a first moment and target process data of a virtual event 504 at the first moment are obtained. An evaluated performance value of the target device 502 at the first moment is determined based on the target hardware parameter at the first moment and the target process data at the first moment. When a first preset threshold of the target device 502 at the first moment is obtained, the first preset threshold is compared with the evaluated performance value at the first moment to obtain a first comparison result. Adjustment is performed on the target device 502 at the first moment based on the first comparison result, and adjustment information 506 at the first moment is displayed on a test interface of the virtual event 504. Assuming that the target device 502 is a test device, the adjustment information 506 at the first moment may be displayed on a display interface of the target device 502, for example, “restore an animation frame rate, turn on anti-aliasing, and increase a first-level current”, but this is not limited thereto. When a first execution result of the virtual event 504 at the first moment and a second execution result of the virtual event 504 at a second moment are obtained, the first execution result is compared with the second execution result to obtain a second comparison result. The first preset threshold is adjusted based on the second comparison result, to obtain a second preset threshold of the target device 502 at the second moment. Adjustment is performed on the target device 502 at the second moment by using the second preset threshold and target hardware parameter at the second moment.

According to this embodiment provided in this disclosure, the target hardware parameter of the target device at the first moment and the target process data of the virtual event at the first moment are obtained, the target device being the execution device participating in the virtual event, the target hardware parameter being the hardware usage parameter when the target device participates in the virtual event, and the target process data being the process data affecting the performance of the target device during execution of the virtual event. The evaluated performance value of the target device at the first moment is determined based on the target hardware parameter at the first moment and the target process data at the first moment, the evaluated performance value being configured for evaluating the degree of matching between the performance of the target device and the virtual event. When the first preset threshold of the target device at the first moment is obtained, the first preset threshold is compared with the evaluated performance value at the first moment to obtain the first comparison result. Adjustment is performed on the target device at the first moment based on the first comparison result, to obtain the target hardware parameter of the target device at the second moment, the second moment being the next moment following the first moment. When the first execution result of the virtual event at the first moment and the second execution result of the virtual event at the second moment are obtained, the first execution result is compared with the second execution result to obtain the second comparison result. The first preset threshold is adjusted based on the second comparison result, to obtain the second preset threshold of the target device at the second moment. Adjustment is performed on the target device at the second moment by using the second preset threshold and the target hardware parameter at the second moment. The device performance at the current moment is determined by evaluating the performance of the target device by using the hardware parameter and the process data, and positive configuration adjustment is performed on the target device through comparison of the performance and the preset threshold. In addition, to further improve accuracy of device configuration adjustment, error comparison is further performed on event execution results at different moments, to adjust the preset threshold configured for comparison, so that an objective of efficiently completing the device configuration adjustment and further improving the accuracy of the device configuration adjustment is achieved, thereby achieving the technical effect of achieving the high efficiency and the high accuracy of the device configuration adjustment at the same time.

In some embodiments, before that the first preset threshold is adjusted based on the second comparison result, to obtain a second preset threshold of the target device at the second moment, the method further includes: comparing, when an expected execution result of the virtual event is obtained, the second execution result with the expected execution result to obtain a third comparison result.

That the first preset threshold is adjusted based on the second comparison result, to obtain a second preset threshold of the target device at the second moment includes: adjusting the first preset threshold based on the second comparison result and the third comparison result, to obtain the second preset threshold.

In some embodiments of this disclosure, the second comparison result may be, but is not limited to, configured for representing an execution result error between two different moments, so that a device configuration adjustment trend may be determined based on the second comparison result. If the execution result error is large and is a positive error, the device configuration adjustment tends to be proper. Conversely, if the execution result error is small or is a negative error, the device configuration adjustment tends to be improper, and an adjustment manner towards being proper needs to be re-formulated. When an execution result is a frame rate, if the execution result error is large, the error is positive, and an error change rate is positive, a current frame rate is higher than a target frame rate and tends to increase. In this case, hardware has a capability to perform rendering with high image quality. Therefore, upgrading adjustment needs to be performed. If the execution result error is small, or the error is negative and an error change rate is negative, a current frame rate is lower than a target frame rate and tends to decrease. In this case, a probability of a lag occurring in a game increases. Therefore, downgrading adjustment needs to be performed to reduce a quantity of times of frame freezing.

In some embodiments of this disclosure, the third comparison result may be, but is not limited to, configured for representing an execution result error between an adjusted execution result and an expected execution result, so that a device configuration adjustment trend may also be determined based on the third comparison result. If the execution result error is large and is a positive error, the device configuration adjustment tends to be proper. Conversely, if the execution result error is small or is a negative error, the device configuration adjustment tends to be improper, and an adjustment manner towards being proper needs to be re-formulated.

To further improve the accuracy of the device configuration adjustment, the device configuration adjustment trend may be determined more precisely with reference to the second comparison result and the third comparison result.

According to this embodiment provided in this disclosure, when the expected execution result of the virtual event is obtained, the second execution result is compared with the expected execution result, to obtain the third comparison result. The first preset threshold is adjusted based on the second comparison result and the third comparison result, to obtain the second preset threshold. Therefore, an objective of more precisely determining the device configuration adjustment trend is achieved, thereby achieving an effect of improving the accuracy of the device configuration adjustment.

As a solution, that the first preset threshold is adjusted based on the second comparison result and the third comparison result, to obtain the second preset threshold includes:
increasing, when the second comparison result indicates that the second execution result is superior to the first execution result and the third comparison result indicates that the second execution result is superior to the expected execution result, the first preset threshold to obtain an increased first preset threshold, and using the increased first preset threshold as the second preset threshold; or
reducing, when the second comparison result indicates that the second execution result is inferior to the first execution result and the third comparison result indicates that the second execution result is inferior to the expected execution result, the first preset threshold to obtain a reduced first preset threshold, and using the reduced first preset threshold as the second preset threshold.

Although the accuracy of the device configuration adjustment may be further improved with reference to the second comparison result and the third comparison result, complexity is also correspondingly increased with a quantity of reference parameters for adjustment. Therefore, to clarify adjustment manners for the second comparison result and the third comparison result, the preset threshold is correspondingly increased or the preset threshold is correspondingly reduced in various situations.

For further example, as shown in FIG. 6, a difference between execution results may be calculated to determine whether an execution result is superior or inferior. For example, a first difference between the second execution result and the first execution result, and a second difference between the expected execution result and the second execution result are calculated, then when it is determined that the first difference and the second difference are both positive, the second execution result is superior to the first execution result, and the third comparison result indicates that the second execution result is superior to the expected execution result, so that the first preset threshold is increased. When the first difference and the second difference are both negative, the second execution result is inferior to the first execution result, and the third comparison result indicates that the second execution result is inferior to the expected execution result, so that the first preset threshold is reduced.

According to this embodiment provided in this disclosure, the first preset threshold is increased when the second comparison result indicates that the second execution result is superior to the first execution result, and the third comparison result indicates that the second execution result is superior to the expected execution result, to obtain a first target preset threshold, the first target preset threshold being greater than the first preset threshold. Alternatively, the first preset threshold is reduced when the second comparison result indicates that the second execution result is inferior to the first execution result, and the third comparison result indicates that the second execution result is inferior to the expected execution result, to obtain a second target preset threshold, the second target preset threshold being less than the first preset threshold. Therefore, an objective of more precisely determining the device configuration adjustment trend is achieved, thereby achieving an effect of improving the accuracy of the device configuration adjustment.

In some embodiments, before increasing the first preset threshold to obtain the first target preset threshold, the method further includes:

S1-1: Integrate, when a first difference corresponding to the second comparison result and a second difference corresponding to the third comparison result are obtained, the first difference with the second difference to obtain a target difference. For example, the first difference and the second difference may be summed to obtain the target difference.

S1-2: Obtain a threshold adjustment amount matching the target difference.

Increasing the first preset threshold, to obtain an increased first preset threshold includes: increasing the first preset threshold based on the threshold adjustment amount, to obtain the increased first preset threshold.

In some embodiments of this disclosure, a preset difference mapping table may be used to match the threshold adjustment amount, but this is not limited thereto. For example, the target difference obtained by integrating the first difference with the second difference may be, but is not limited to, the first difference, the second difference, or a sum of the first difference and the second difference. Further, the threshold adjustment amount matching the target difference may be determined in the difference mapping table.

In some embodiments of this disclosure, a more fine-grained adjustment manner may be used, but this is not limited thereto. It is assumed that the difference includes five levels: −2, −1, 0, 1, and 2. After the first difference and the second difference are obtained, the first difference and the second difference are integrated based on the five levels, to obtain the target difference.

For further example, if the first difference is 1, and the second difference is 2, the obtained target difference is 1 plus 2, that is, 3. Then, the threshold adjustment amount matching 3 is determined from the preset difference mapping table. Threshold adjustment amounts matching various differences may be recorded in the preset difference mapping table, for example, a threshold adjustment amount matching −4 is −4, a threshold adjustment amount matching −3 is −3, a threshold adjustment amount matching −2 is −2, a threshold adjustment amount matching −1 is −1, a threshold adjustment amount matching 0 is 0, a threshold adjustment amount matching 1 is 1, a threshold adjustment amount matching 2 is 2, a threshold adjustment amount matching 3 is 3, and a threshold adjustment amount matching 4 is 4, but this is not limited thereto. That a threshold adjustment amount is negative may represent, but is not limited to, reducing a preset threshold.

To refine an adjustment granularity of the preset threshold, when the first difference corresponding to the second comparison result and the second difference corresponding to the third comparison result are obtained, the first difference and the second difference are integrated, to obtain the target difference, and the preset threshold is further adjusted based on the threshold adjustment amount matching the target difference.

According to this embodiment provided in this disclosure, when the first difference corresponding to the second comparison result and the second difference corresponding to the third comparison result are obtained, the first difference and the second difference are integrated, to obtain the target difference. The threshold adjustment amount matching the target difference is obtained. The first preset threshold is increased based on the threshold adjustment amount, to obtain the first target preset threshold. Therefore, an objective of refining the adjustment granularity of the preset threshold is achieved, thereby achieving a technical effect of improving accuracy of preset threshold adjustment.

In some embodiments, the updating the target hardware parameter of the target device at the first moment based on the first comparison result, to obtain a target hardware parameter of the target device at a second moment includes: adjusting a target configuration parameter of the target device at the first moment based on the first comparison result, to update the target hardware parameter at the first moment to a target hardware parameter corresponding to an adjusted target configuration parameter at the first moment, and using the updated target hardware parameter as the target hardware parameter of the target device at the second moment, the target configuration parameter being an execution configuration parameter set by the target device in the virtual event, and the target configuration parameter being associated with the target hardware parameter.

The performing adjustment on the target device at the second moment by using the second preset threshold and the target hardware parameter at the second moment includes: adjusting a target configuration parameter of the target device at the second moment by using the second preset threshold and the target hardware parameter at the second moment.

In some embodiments of this disclosure, the target configuration parameter is an execution configuration parameter set by the target device in the virtual event, such as a display parameter (image quality of different levels, display or hide options, or the like), a function parameter (enabling or disabling a particular function), or an operation parameter that is set by the target device in the virtual event.

In some embodiments of this disclosure, adjustment on the target device at different moments may include, but is not limited to, direct adjustment and indirect adjustment. The direct adjustment may be, but is not limited to, adjustment on a target hardware parameter of the target device. The indirect adjustment may be, but is not limited to, adjustment on a target configuration parameter that is of the target device and that is associated with the target hardware parameter. For a user, adjustment on the target hardware parameter needs a threshold, and the target configuration parameter is usually set on a configuration interface of the virtual event, which is more beneficial to adjustment by the user, so that efficiency of the device configuration adjustment is improved.

According to this embodiment provided in this disclosure, the target configuration parameter of the target device at the first moment is adjusted based on the first comparison result, to obtain the target hardware parameter of the target device at the second moment, the target configuration parameter being the execution configuration parameter set by the target device in the virtual event, and the target configuration parameter being associated with the target hardware parameter. The target configuration parameter of the target device at the second moment is adjusted by using the second preset threshold and the target hardware parameter at the second moment, to further facilitate the adjustment by the user, thereby achieving a technical effect of improving the efficiency of the device configuration adjustment.

In some embodiments, the adjusting a target configuration parameter of the target device at the second moment by using the second preset threshold and the target hardware parameter at the second moment includes:
S2-1: Determine, when target process data of the virtual event at the second moment is obtained, an evaluated performance value of the target device at the second moment based on the target hardware parameter at the second moment and the target process data at the second moment.
S2-2: Compare the second preset threshold with the evaluated performance value at the second moment, to obtain a fourth comparison result.
S2-3: Adjust the target configuration parameter of the target device at the second moment based on the fourth comparison result, to obtain a target hardware parameter of the target device at a third moment, the third moment being a next moment following the second moment.
S2-4: Compare, when a third execution result of the virtual event at the third moment is obtained, the third execution result with the second execution result to obtain a fifth comparison result.
S2-5: Adjust the second preset threshold based on the fifth comparison result, to obtain a third preset threshold of the target device at the third moment.
S2-6: Adjust a target configuration parameter of the target device at the third moment by using the third preset threshold and the target hardware parameter at the third moment.

In some embodiments, before the determining an evaluated performance value of the target device at the first moment based on the target hardware parameter at the first moment and the target process data at the first moment, the method further includes: obtaining a first weight assigned to the target hardware parameter and a second weight assigned to the target process data; and

the determining an evaluated performance value of the target device at the first moment based on the target hardware parameter at the first moment and the target process data at the first moment includes:
S3-1: Calculate the target hardware parameter at the first moment based on the first weight, to obtain an evaluated hardware parameter, and calculate the target process data at the first moment based on the second weight, to obtain evaluated process data.
S3-2: Integrate the evaluated hardware parameter with the evaluated process data, to obtain the evaluated performance value at the first moment.

For example, when the evaluated hardware parameter is integrated with the evaluated process data, the weighted evaluated hardware parameter and evaluated process data may be summed, to obtain the evaluated performance value at the first moment. Other processing may further be performed, for example, the weighted evaluated hardware parameter and evaluated process data are summed and averaged, to obtain the evaluated performance value at the first moment. This is not limited in embodiments of this disclosure.

To comprehensively determine, based on a plurality of dimensions, whether adjustment needs to be performed and a corresponding adjustment manner to be selected, a corresponding weight is assigned to each parameter based on a correlation degree between the parameter and game performance. A higher weight indicates a higher correlation, so that the accuracy of the device configuration adjustment is improved.

According to this embodiment provided in this disclosure, the first weight assigned to the target hardware parameter and the second weight assigned to the target process data are obtained. The target hardware parameter at the first moment is calculated based on the first weight, to obtain the evaluated hardware parameter, and the target process data at the first moment is calculated based on the second weight, to obtain evaluated process data. The evaluated hardware parameter and the evaluated process data are integrated to obtain the evaluated performance value at the first moment. Therefore, an objective of comprehensive adjustment determining based on the plurality of dimensions is achieved, thereby achieving a technical effect of improving the accuracy of the device configuration adjustment.

In some embodiments, the determining an evaluated performance value of the target device at the first moment based on the target hardware parameter at the first moment and the target process data at the first moment includes: determining an evaluated downgrading value of the target device at the first moment and an evaluated upgrading value of the target device at the first moment based on the target hardware parameter at the first moment and the target process data at the first moment.

The first preset threshold includes a preset downgrading threshold and a preset upgrading threshold, and the updating the target hardware parameter of the target device at the first moment based on the first comparison result, to obtain a target hardware parameter of the target device at a second moment includes at least one of the following:
performing downgrading adjustment on the target configuration parameter of the target device at the first moment when the first comparison result indicates that the evaluated downgrading value is greater than the preset downgrading threshold, to update the target hardware parameter at the first moment to a target hardware parameter corresponding to a target configuration parameter at the first moment obtained through the downgrading adjustment, and using the updated target hardware parameter as the target hardware parameter of the target device at the second moment; or
performing upgrading adjustment on the target configuration parameter of the target device at the first moment when the first comparison result indicates that the evaluated upgrading value is less than the preset upgrading threshold, to update the target hardware parameter at the first moment to a target hardware parameter corresponding to a target configuration parameter at the first moment obtained through the upgrading adjustment, and using the updated target hardware parameter as the target hardware parameter of the target device at the second moment.

To improve fineness of an adjustment manner, the evaluated performance value is subdivided into the evaluated downgrading value and the evaluated upgrading value, and in a subsequent process of performing adjustment on the target device at the first moment based on the first comparison result, the evaluated downgrading value and the evaluated upgrading value are respectively determined. If the evaluated downgrading value is determined to obtain a conclusion that downgrading needs to be performed, the downgrading is performed, or if the evaluated upgrading value is determined to obtain a conclusion that upgrading needs to be performed, the upgrading is performed.

According to this embodiment provided in this disclosure, the evaluated downgrading value of the target device at the first moment and the evaluated upgrading value of the target device at the first moment are determined based on the target hardware parameter at the first moment and the target process data at the first moment. Downgrading adjustment is performed on the target device at the first moment when the first comparison result indicates that the evaluated downgrading value is greater than the preset downgrading threshold, to obtain the target hardware parameter of the target device at the second moment, the first preset threshold including the preset downgrading threshold. Upgrading adjustment is performed on the target device at the first moment when the first comparison result indicates that the evaluated upgrading value is less than the preset upgrading threshold, to obtain the target hardware parameter of the target device at the second moment, the first preset threshold including the preset upgrading threshold. Therefore, an objective of improving the fineness of the adjustment manner is achieved, thereby achieving the technical effect of improving the accuracy of the device configuration adjustment.

In some embodiments, the obtaining a target hardware parameter of a target device at a first moment and target process data of a virtual event at the first moment includes: obtaining the target hardware parameter at the first moment and virtual object data of a virtual game match at the first moment, the virtual game match being a round of a virtual game in which a virtual character participates under control of the target device, and the virtual object data being virtual object data presented in the virtual game match.

The comparing, when a first execution result of the virtual event at the first moment and a second execution result of the virtual event at the second moment are obtained, the first execution result with the second execution result to obtain a second comparison result includes: comparing, when a first game frame rate of the virtual game match at the first moment and a second game frame rate of the virtual event at the second moment are obtained, the first game frame rate with the second game frame rate to obtain the second comparison result, the second comparison result being configured for indicating a frame rate difference between the first game frame rate and the second game frame rate.

The virtual game match, as a particular virtual event, needs a high degree of matching presented between the performance of the target device and the virtual game match, to bring full game experience to a player, which is most directly reflected in a game frame rate. Further, in this embodiment, the game frame rate is used as an adjustment reference of a preset threshold, so that an optimization degree for the game frame rate before adjustment and after adjustment may be maximally determined, so as to improve pertinence of target device adjustment, thereby improving accuracy of adjustment on the particular virtual event, that is, the virtual game match.

According to this embodiment provided in this disclosure, the target hardware parameter at the first moment and the virtual object data of the virtual game match at the first moment are obtained, the virtual game match being a round of the virtual game in which the virtual character participates under control of the target device, and the virtual object data being the virtual object data presented in the virtual game match. When the first game frame rate of the virtual game match at the first moment and the second game frame rate of the virtual event at the second moment are obtained, the first game frame rate is compared with the second game frame rate, to obtain the second comparison result, the second comparison result being configured for indicating the frame rate difference between the first game frame rate and the second game frame rate. Therefore, an objective of improving the pertinence of the target device adjustment is achieved, thereby achieving a technical effect of improving the accuracy of the adjustment on the particular virtual event, that is, the virtual game match.

In some embodiments, for ease of understanding, the foregoing device configuration adjustment method is applied to a game configuration adjustment scenario, so that a game configuration adjustment system has an error feedback mechanism, to implement auto-adjustment of an adjustment parameter.

In some embodiments of this disclosure, after game configuration adjustment is enabled in game, whether a parameter of the game configuration adjustment system needs to be adjusted is calculated based on a current adjustment result and a current frame rate. After training using data of a plurality of rounds of game, the parameter of the system converges and fluctuates within a small range. In addition, after each adjustment action, the parameter of the game configuration adjustment system is adjusted by using a fuzzy control system, so that the parameter of the system converges to a parameter value suitable for a corresponding device.

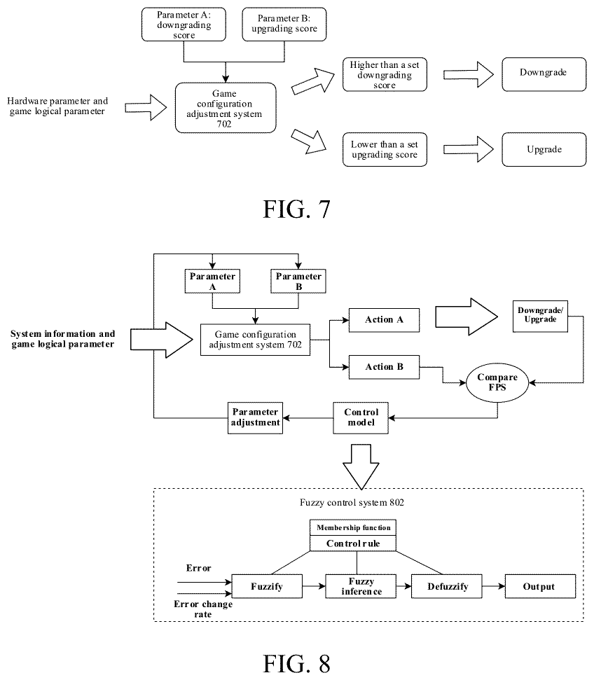

Further, for example, the game configuration adjustment system is shown in FIG. 7. The game configuration adjustment system 702 scores a game running state, and performs game adjustment based on a score. To comprehensively determine, based on a plurality of dimensions, whether downgrading/upgrading needs to be performed, a corresponding weight is assigned to each parameter based on a correlation degree between the parameter and game performance. A higher weight indicates a higher correlation. Weighted sum is performed on a plurality of parameters that are normalized, to obtain a score, and whether downgrading/upgrading needs to be performed is determined based on the score. A normalization method is to divide an obtained parameter by a set parameter, and the following describes specific determination of a score:

$$Downgrading score = 0.3 \times CPU + 0.3 \times GPU + 0.7 \times on - screen object quantity + 0.7 \times on - screen special effect quantity \qquad Parameter A$$

$$Upgrading score = 0.2 \times CPU + 0.2 \times GPU + 0.6 \times min ( on - screen special effect quantity , on - screen object quantity ) \qquad Parameter B$$

Parameters of the CPU and the GPU are hardware parameters, the on-screen object quantity and the on-screen special effect quantity are game logical parameters. The on-screen object quantity is a quantity of objects that appear on the same screen simultaneously during game running, and the on-screen special effect quantity is a quantity of special effects that appear on the same screen simultaneously during the game running. Further, when a current downgrading score is higher than a set downgrading threshold, game configuration downgrading is performed. When a current upgrading score is lower than a set upgrading threshold, game configuration upgrading is performed.

In some embodiments, the fuzzy control system is based on a scenario shown in FIG. 7. As shown in FIG. 8, fuzzy control is applied to parameter auto-adjustment of the game configuration adjustment system 702 based on a fuzzy control system 802, so that the game configuration adjustment system 702 is capable of auto-correction when improper adjustment occurs. Specifically, the game configuration adjustment system 702 only performs a forward computation process. Based on this, a fuzzy control-based error feedback link is added, so that with continuous iterations, a parameter of the game configuration adjustment system 702 gradually converges to a state most suitable for a current device. For example, an action A is the forward computation process of the game configuration adjustment system 702, and an action B is the added fuzzy control-based error feedback link, to compare frames per second (FPS) of a picture.

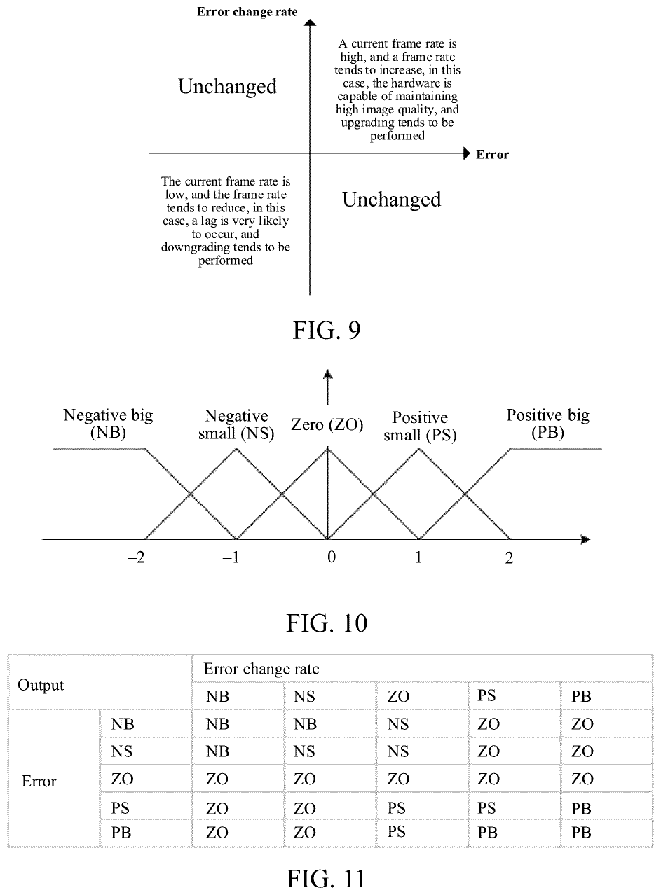

Further, in this embodiment, for the fuzzy control system 802, a frame rate is selected as a reference for fuzzy control input. A difference between a current frame rate and a target frame rate is used as an error, and a difference between the current frame rate and a previous frame rate is used as an error change rate. The error reflects a current frame rate situation, and the error change rate reflects a change trend of a frame rate. A fuzzy control rule is formulated based on a requirement. When the error is positive and the error change rate is positive, the current frame rate is higher than the target frame rate and tends to increase. In this case, hardware has a capability to perform rendering with high image quality. Therefore, the game configuration adjustment system tends to perform upgrading. When the error is negative and the error change rate is negative, the current frame rate is lower than the target frame rate and tends to decrease. In this case, a probability of a lag in a game increases. Therefore, the game configuration adjustment system tends to perform downgrading, to reduce a quantity of lags. Specifically, a relationship between the error and the error change rate is shown in FIG. 9. When the error and the error change rate are both positive, the current frame rate is high, and a frame rate tends to increase. In this case, the hardware is capable of maintaining high image quality, and upgrading tends to be performed. When the error and the error change rate are both negative, the current frame rate is low, and the frame rate tends to decrease. In this case, a lag is very likely to occur, and therefore downgrading tends to be performed. The configuration remains unchanged in other cases.

In this embodiment of this disclosure, based on fuzzy control, a membership function is designed to fuzzify a precise input value and defuzzify a fuzzy output value, and a corresponding fuzzy control table is created to implement mapping from input to output. The designed membership function is as shown in the following formula:

$$μ = \{ \begin{matrix}{μ}_{NB} ( x ) = \{ \begin{matrix}1 & x \leq - 2 \\ - x - 1 & - 2 \leq x \leq - 1\end{matrix} \\ {μ}_{NS} ( x ) = \{ \begin{matrix}x + 2 & - 2 \leq x \leq - 1 \\ - x & - 1 \leq x \leq 0\end{matrix} \\ {μ}_{ZO} ( x ) = \{ \begin{matrix}x + 1 & - 1 \leq x \leq 0 \\ - x + 1 & 0 \leq x \leq 1\end{matrix} \\ {μ}_{PS} ( x ) = \{ \begin{matrix}x & 0 \leq x \leq 1 \\ - x + 2 & 1 \leq x \leq 2\end{matrix} \\ {μ}_{PB} ( x ) = \{ \begin{matrix}x - 1 & 1 \leq x \leq 2 \\ 1 & 2 \leq x\end{matrix}\end{matrix} \qquad ( 1 )$$

Further, as shown in FIG. 10, it is assumed that a fuzzy word set is {NB, NS, ZO, PS, PB}, and quantized domain of discourse is {−2, −1, 0, 1, 2}, which respectively represent negative big, negative small, zero, positive small, and positive big. Actual domain of discourse of input is within [−10, 10], and is first linearly scaled down to the quantized domain of discourse. Then, the input is classified into a corresponding fuzzy set by using the following membership function. Actual domain of discourse of output is within [−0.02, 0.02], and an output result in the quantized domain of discourse is scaled to obtain an actual output result.

In some embodiments of this disclosure, the fuzzy control table is created according to the fuzzy control rule, which is specifically shown in FIG. 11. After the error and the error change rate are mapped to a corresponding fuzzy set by using the membership function, the fuzzy control table is queried to obtain a fuzzy set to which the output belongs. For the fuzzy set to which the input is mapped, a membership degree may be calculated based on the membership function. The membership degree indicates a degree to which the input belongs to the fuzzy set, and a smaller value is used. For each corresponding fuzzy control rule, an output membership degree is obtained. Output membership degrees corresponding to all rules for each fuzzy subset are summed, to obtain a total output membership degree. Then, the output is defuzzified by using a center of gravity method, to obtain a precise parameter adjustment value. That the output is positive indicates that upgrading tends to be performed. Therefore, a downgrading threshold and an upgrading threshold are increased, so that downgrading is more difficult and upgrading is easier. That the output is negative indicates that downgrading tends to be performed. Therefore, the downgrading threshold and the upgrading threshold are reduced, so that the upgrading is more difficult and the downgrading is easier. A parameter adjustment value separately is added to a downgrading threshold parameter and an upgrading threshold parameter in the game configuration adjustment system, to obtain a new threshold parameter for a further iteration, to make the threshold parameter converge. Refer to the following formula (2) for details:

$${v}_{0} = \frac{\int v {μ}_{v} ( v ) dv}{\int {μ}_{v} ( v ) dv} \qquad ( 2 )$$

According to this embodiment provided in this disclosure, as the fuzzy control iterates continuously, the parameter gradually converges and eventually fluctuates within a small range. Performance data corresponding to a converged parameter throughout an entire game is basically consistent with initial global downgraded performance data, but duration in top configuration increases, to maximize an image quality level in the game as much as possible while ensuring performance.

In the specific implementation of this disclosure, related data such as user information is involved. When the foregoing embodiments of this disclosure are applied to a specific product or technology, a permission or consent of a user is required, and collection, use, and processing of the related data need to comply with relevant laws, regulations, and standards of relevant countries and regions.

For each of the foregoing method embodiments, for ease of description, the method embodiments are described as a series of action combination. But a person of ordinary skill in the art is to know that this disclosure is not limited to any described sequence of the action, as some operations can use other sequences or can be executed simultaneously according to this disclosure. In addition, a person skilled in the art is also to learn that the embodiments described in this specification are all example embodiments, and the involved actions and modules are not necessarily required to this disclosure.

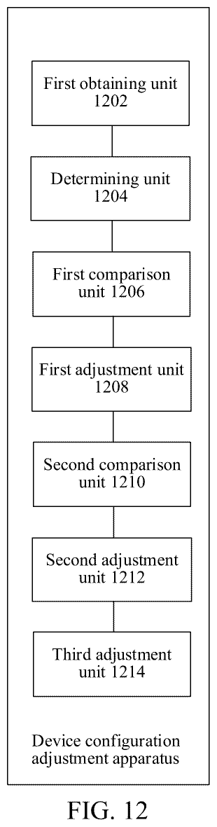

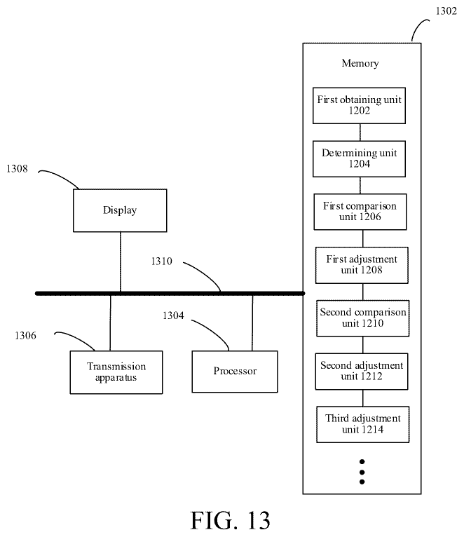

According to another aspect of embodiments of this disclosure, a device configuration adjustment apparatus for implementing the foregoing device configuration adjustment method is further provided. As shown in FIG. 12, the apparatus includes:

a first obtaining unit 1202, configured to obtain a target hardware parameter of a target device at a first moment and target process data of a virtual event at the first moment, the target device being an execution device participating in the virtual event, the target hardware parameter being a hardware usage parameter when the target device participates in the virtual event, and the target process data being process data affecting performance of the target device during execution of the virtual event;

a determining unit 1204, configured to determine an evaluated performance value of the target device at the first moment based on the target hardware parameter at the first moment and the target process data at the first moment, the evaluated performance value being configured for indicating a degree of matching between the performance of the target device and the virtual event;

a first comparison unit 1206, configured to compare, when a first preset threshold of the target device at the first moment is obtained, the first preset threshold with the evaluated performance value at the first moment to obtain a first comparison result;

a first adjustment unit 1208, configured to update the target hardware parameter of the target device at the first moment based on the first comparison result, to obtain a target hardware parameter of the target device at a second moment, the second moment being a next moment following the first moment;

a second comparison unit 1210, configured to compare, when a first execution result of the virtual event at the first moment and a second execution result of the virtual event at the second moment are obtained, the first execution result with the second execution result to obtain a second comparison result;

a second adjustment unit 1212, configured to adjust the first preset threshold based on the second comparison result, to obtain a second preset threshold of the target device at the second moment; and

a third adjustment unit 1214, configured to perform adjustment on the target device at the second moment by using the second preset threshold and the target hardware parameter at the second moment.

For specific embodiments, reference may be made to the example shown in the foregoing device configuration adjustment method. Detailed descriptions are not provided again in this example.

In some embodiments, the apparatus further includes: a third comparison unit, configured to: before the adjusting of the first preset threshold based on the second comparison result, to obtain the second preset threshold of the target device at the second moment, compare, when an expected execution result of the virtual event is obtained, the second execution result with the expected execution result to obtain a third comparison result.

The second adjustment unit 1212 includes a first adjustment module, configured to adjust the first preset threshold based on the second comparison result and the third comparison result, to obtain the second preset threshold.

For specific embodiments, reference may be made to the example shown in the foregoing device configuration adjustment method. Detailed descriptions are not provided again in this example.

In some embodiments, the first adjustment module includes:
a first adjustment submodule, configured to increase, when the second comparison result indicates that the second execution result is superior to the first execution result and the third comparison result indicates that the second execution result is superior to the expected execution result, the first preset threshold to obtain an increased first preset threshold, and use the increased first preset threshold as the second preset threshold; or
a second adjustment submodule, configured to reduce, when the second comparison result indicates that the second execution result is inferior to the first execution result and the third comparison result indicates that the second execution result is inferior to the expected execution result, the first preset threshold to obtain a reduced first preset threshold, and use the reduced first preset threshold as the second preset threshold.

For specific embodiments, reference may be made to the example shown in the foregoing device configuration adjustment method. Detailed descriptions are not provided again in this example.

In some embodiments, the first adjustment module further includes:
an integration submodule, configured to: before the increasing of the first preset threshold to obtain the increased first preset threshold, integrate, when a first difference corresponding to the second comparison result and a second difference corresponding to the third comparison result are obtained, the first difference with the second difference to obtain a target difference;
an obtaining submodule, configured to: before increasing the first preset threshold to obtain a first target preset threshold, obtain a threshold adjustment amount matching the target difference; and
the first adjustment submodule, configured to increase the first preset threshold based on the threshold adjustment amount, to obtain the increased first preset threshold.

For specific embodiments, reference may be made to the example shown in the foregoing device configuration adjustment method. Detailed descriptions are not provided again in this example.

In some embodiments, the first adjustment unit 1208 includes a second adjustment module, configured to adjust a target configuration parameter of the target device at the first moment based on the first comparison result, to update the target hardware parameter at the first moment to a target hardware parameter corresponding to an adjusted target configuration parameter at the first moment, and use the updated target hardware parameter as the target hardware parameter of the target device at the second moment, the target configuration parameter being an execution configuration parameter set by the target device in the virtual event, and the target configuration parameter being associated with the target hardware parameter.

The third adjustment unit 1214 includes a third adjustment module, configured to adjust a target configuration parameter of the target device at the second moment by using the second preset threshold and the target hardware parameter at the second moment.

For specific embodiments, reference may be made to the example shown in the foregoing device configuration adjustment method. Detailed descriptions are not provided again in this example.

In some embodiments, the third adjustment module includes:
a determining submodule, configured to determine, when target process data of the virtual event at the second moment is obtained, an evaluated performance value of the target device at the second moment based on the target hardware parameter at the second moment and the target process data at the second moment;
a comparison submodule, configured to compare the second preset threshold with the evaluated performance value at the second moment, to obtain a fourth comparison result;
a third adjustment submodule, configured to adjust the target configuration parameter of the target device at the second moment based on the fourth comparison result, to obtain a target hardware parameter of the target device at a third moment, the third moment being a next moment following the second moment;
a comparison submodule, configured to compare, when a third execution result of the virtual event at the third moment is obtained, the third execution result with the second execution result to obtain a fifth comparison result;
a fourth adjustment submodule, configured to adjust the second preset threshold based on the fifth comparison result, to obtain a third preset threshold of the target device at the third moment; and
a fifth adjustment submodule, configured to adjust a target configuration parameter of the target device at the third moment by using the third preset threshold and the target hardware parameter at the third moment.

For specific embodiments, reference may be made to the example shown in the foregoing device configuration adjustment method. Detailed descriptions are not provided again in this example.

In some embodiments, the apparatus further includes: a second obtaining unit, configured to: before the determining of an evaluated performance value of the target device at the first moment based on the target hardware parameter at the first moment and the target process data at the first moment, obtain a first weight assigned to the target hardware parameter and a second weight assigned to the target process data.

The first comparison unit 1204 includes:
a first calculation module, configured to calculate the target hardware parameter at the first moment based on the first weight, to obtain an evaluated hardware parameter, and calculate the target process data at the first moment based on the second weight, to obtain evaluated process data; and
a second calculation module, configured to integrate the evaluated hardware parameter with the evaluated process data, to obtain the evaluated performance value at the first moment.

For specific embodiments, reference may be made to the example shown in the foregoing device configuration adjustment method. Detailed descriptions are not provided again in this example.

In some embodiments, the first comparison unit 1204 includes a determining module, configured to determine an evaluated downgrading value of the target device at the first moment and an evaluated upgrading value of the target device at the first moment based on the target hardware parameter at the first moment and the target process data at the first moment.

The first preset threshold includes a preset downgrading threshold and a preset upgrading threshold, and the first adjustment unit 1208 includes at least one of the following:

a downgrading module, configured to perform downgrading adjustment on the target configuration parameter of the target device at the first moment when the first comparison result indicates that the evaluated downgrading value is greater than the preset downgrading threshold, to update the target hardware parameter at the first moment to a target hardware parameter corresponding to a target configuration parameter at the first moment obtained through the downgrading adjustment, and use the updated target hardware parameter as the target hardware parameter of the target device at the second moment; or

an upgrading module, configured to perform upgrading adjustment on the target configuration parameter of the target device at the first moment when the first comparison result indicates that the evaluated upgrading value is less than the preset upgrading threshold, to update the target hardware parameter at the first moment to a target hardware parameter corresponding to a target configuration parameter at the first moment obtained through the upgrading adjustment, and use the updated target hardware parameter as the target hardware parameter of the target device at the second moment.

For specific embodiments, reference may be made to the example shown in the foregoing device configuration adjustment method. Detailed descriptions are not provided again in this example.

In some embodiments, the first obtaining unit 1202 includes an obtaining module, configured to obtain the target hardware parameter at the first moment and virtual object data of a virtual game match at the first moment, the virtual game match being a round of a virtual game in which a virtual character participates under control of the target device, and the virtual object data being virtual object data presented in the virtual game match.

The second comparison unit 1210 includes a comparison module, configured to compare, when a first game frame rate of the virtual game match at the first moment and a second game frame rate of the virtual event at the second moment are obtained, the first game frame rate with the second game frame rate to obtain the second comparison result, the second comparison result being configured for indicating a frame rate difference between the first game frame rate and the second game frame rate.

For specific embodiments, reference may be made to the example shown in the foregoing device configuration adjustment method. Detailed descriptions are not provided again in this example.

According to another aspect of embodiments of this disclosure, an electronic device configured to implement the foregoing device configuration adjustment method is further provided. The electronic device may be, but is not limited to, the user device 102 or the server 112 shown in FIG. 1. In an embodiment, an example in which the electronic device is the user device 102 is used for description. Further, as shown in FIG. 13, the electronic device includes a memory 1302 and a processor 1304. The memory 1302 has a computer program stored therein, and the processor 1304 is configured to perform operations in any one of the foregoing method embodiments by using the computer program.

In this embodiment, the electronic device may be located in at least one of a plurality of network devices in a computer network.

In this embodiment, the processor may be configured to execute the computer program to perform the following operations.
S1: Obtain a target hardware parameter of a target device at a first moment and target process data of a virtual event at the first moment, the target device being an execution device participating in the virtual event, the target hardware parameter being a hardware usage parameter when the target device participates in the virtual event, and the target process data being process data affecting performance of the target device during execution of the virtual event.
S2: Determine an evaluated performance value of the target device at the first moment based on the target hardware parameter at the first moment and the target process data at the first moment, the evaluated performance value being configured for indicating a degree of matching between the performance of the target device and the virtual event.
S3: Compare, when a first preset threshold of the target device at the first moment is obtained, the first preset threshold with the evaluated performance value at the first moment to obtain a first comparison result.
S4: Update the target hardware parameter of the target device at the first moment based on the first comparison result, to obtain a target hardware parameter of the target device at a second moment, the second moment being a next moment following the first moment.
S5: Compare, when a first execution result of the virtual event at the first moment and a second execution result of the virtual event at the second moment are obtained, the first execution result with the second execution result to obtain a second comparison result.
S6: Adjust the first preset threshold based on the second comparison result, to obtain a second preset threshold of the target device at the second moment.
S7: Perform adjustment on the target device at the second moment by using the second preset threshold and the target hardware parameter at the second moment.

A person of ordinary skill in the art may understand that, a structure shown in FIG. 13 is only an example, and a structure of the foregoing electronic device is not limited in FIG. 13. For example, the electronic device may further include more or fewer components (for example, a network interface) than those shown in FIG. 13, or has a configuration different from that shown in FIG. 13.

The memory 1302 may be configured to store a software program and a module, such as a program instruction/module corresponding to the device configuration adjustment method and apparatus in embodiments of this disclosure. The processor 1304 runs the software program and the module stored in the memory 1302, to perform various function applications and data processing, in other words, implement the foregoing device configuration adjustment method. The memory 1302 may include a high-speed random memory, and may also include a non-volatile memory, for example, one or more magnetic storage apparatuses, a flash memory, or another nonvolatile solid-state memory. In some embodiments, the memory 1302 may further include memories remotely disposed relative to the processor 1304, and the remote memories may be connected to a user device via a network. Examples of the network include, but are not limited to, the Internet, an intranet, a local area network, a mobile communication network, and a combination thereof. The memory 1302 may be specifically, but is not limited to, configured to store information such as a target hardware parameter, target process data, an evaluated performance value, a first preset threshold, and a second preset threshold. In an example, as shown in FIG. 13, the memory 1302 may include, but is not limited to, the first obtaining unit 1202, the determining unit 1204, the first comparison unit 1206, the first adjustment unit 1208, the second comparison unit 1210, the second adjustment unit 1212, and the third adjustment unit 1214 in the foregoing device configuration adjustment apparatus. In addition, the memory 1302 may further include, but is not limited to, another module unit in the device configuration adjustment apparatus. Details are not described again in this example.

A transmission apparatus 1306 is configured to receive or send data via a network. Specific examples of the foregoing network include a wired network and a wireless network. In an example, the transmission device 1306 includes a network interface controller (NIC). The NIC may be connected to another network device and a router by using a network cable, so as to communicate with the Internet or a local area network. In an example, the transmission device 1306 is a radio frequency (RF) module, which wirelessly communicates with the Internet.

In addition, the electronic device further includes: a display 1308, configured to display information such as the target hardware parameter, the target process data, the evaluated performance value, the first preset threshold, and the second preset threshold; and a connection bus 1310, configured to connect various module components in the electronic device.

In another embodiment, the foregoing user device or server may be a node in a distributed system. The distributed system may be a blockchain system, the blockchain system may be a distributed system formed by connecting a plurality of nodes through network communication. A peer to peer (P2P) network may be formed between the nodes. Any form of a computing device, such as the server, the user device, and another electronic device, may become a node in the blockchain system by joining the peer-to-peer network.

According to an aspect in this disclosure, a computer program product is provided. The computer program product includes a computer program. The computer program includes program code used for performing the method shown in the flowchart. In such an embodiment, the computer program may be downloaded and installed from a network through the communication part, and/or installed from the removable medium. When executed by a central processing unit, the computer program executes functions provided in embodiments of this disclosure.

The sequence numbers of the foregoing embodiments of this disclosure are merely for description purpose but do not imply the preference among the embodiments.

A computer system of the electronic device is merely an example, and does not constitute any limitation on functions and use ranges of embodiments of this disclosure.

The computer system includes a central processing unit (CPU), which may perform various suitable actions and processing according to a program stored in a read-only memory (ROM) or a program loaded from a storage part into a random access memory (RAM). In the random access memory, various programs and data required by system operations are further stored. The central processing unit, the read-only memory, and the random-access memory are connected to each other through a bus. An input/output (I/O) interface is also connected to the bus.

The following components are connected to the input/output interface: an input part including a keyboard, a mouse, or the like; an output part including a cathode ray tube (CRT), a liquid crystal display (LCD), a speaker, or the like; a storage part including a hard disk, or the like; and a communication part including a network interface card such as a local area network (LAN) card or a modem. The communication part performs communication processing over a network such as the Internet. A driver is also connected to the input/output interface as required. A removable medium, such as a magnetic disk, an optical disc, a magneto-optical disk, or a semiconductor memory, is installed on the driver as required, so that a computer program read from the removable medium is installed into the storage part as required.

Particularly, according to an embodiment of this disclosure, the processes described in each method flowchart may be implemented as a computer program. For example, this embodiment of this disclosure includes a computer program product, the computer program product includes a computer program carried on a computer-readable medium, and the computer program includes program code configured for performing the methods shown in the flowcharts. In such an embodiment, the computer program may be downloaded and installed from a network through the communication part, and/or installed from the removable medium. When the computer program is executed by the central processing unit, the various functions defined in the system of this disclosure are executed.

The sequence numbers of the foregoing embodiments of this disclosure are merely for description purpose but do not imply the preference among the embodiments.

When the integrated unit in the foregoing embodiments is implemented in a form of a software functional unit and sold or used as an independent product, the integrated unit may be stored in the foregoing computer-readable storage medium. Based on such understanding, the technical solutions of this disclosure may be implemented in a form of a software product. The computer software product is stored in a storage medium and includes several instructions for instructing one or more electronic devices (which may be a user device, a server, or the like) to perform all or some of operations of the method in embodiments of this disclosure.

In the foregoing embodiments of this disclosure, the descriptions of the embodiments have respective focuses. For a part that is not described in detail in an embodiment, refer to related descriptions in other embodiments.

In the several embodiments provided in this disclosure, the disclosed client may be implemented in another manner. The apparatus embodiments described above are merely examples. For example, the division of the units is merely the division of logical functions, and may use other division manners during actual implementation. For example, a plurality of units or components may be combined, or may be integrated into another system, or some features may be omitted or not performed. In addition, the coupling, or direct coupling, or communication connection between the displayed or discussed components may be the indirect coupling or communication connection through some interfaces, units, or modules, and may be electrical or of other forms.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The units described as separate components may or may not be physically separated, and the components displayed as units may or may not be physical units, and may be located in one place or may be distributed over a plurality of network units. Some or all of the units may be selected according to actual needs to achieve the objectives of the solutions of the embodiments.

In addition, functional units in embodiments of this disclosure may be integrated into one processing unit, or each of the units may be physically separated, or two or more units may be integrated into one unit. The integrated unit may be implemented in the form of hardware, or may be implemented in a form of a software functional unit.

The foregoing descriptions are merely example implementations of this disclosure. A person of ordinary skill in the art may further make several improvements and modifications without departing from the principle of this disclosure, and the improvements and modifications fall within the scope of this disclosure.

What is claimed is:

1. A device configuration adjustment method comprising:
obtaining a first hardware metric of a device at a first moment that the device executes a virtual event;
obtaining process data affecting performance of the device at the first moment;
determining, based on the first hardware metric and the process data, an evaluated performance value at the first moment that indicates a degree of matching between the performance of the device at the first moment and the virtual event;
obtaining a first comparison result based on comparing a first preset threshold of the device with the evaluated performance value;
obtaining a second hardware metric of the device at a second moment based on the first comparison result;
obtaining a second comparison result based on comparing a first execution result of the virtual event at the first moment with a second execution result of the virtual event at the second moment;
obtaining a second preset threshold of the device at the second moment based on adjusting the first preset threshold with the second comparison result; and
adjusting the device at the second moment based on the second preset threshold and the second hardware metric.

2. The method according to claim 1, comprising:
obtaining a third comparison result based on comparing, when an expected execution result of the virtual event is obtained, the second execution result with the expected execution result; and
the obtaining the second preset threshold comprises:
obtaining the second preset threshold based on adjusting the first preset threshold with the second comparison result and the third comparison result.

3. The method according to claim 2, wherein the obtaining the second preset threshold comprises at least one of:
increasing, when the second comparison result indicates that the second execution result is superior to the first execution result and the third comparison result indicates that the second execution result is superior to the expected execution result, the first preset threshold to obtain an increased first preset threshold, and using the increased first preset threshold as the second preset threshold; or
reducing, when the second comparison result indicates that the second execution result is inferior to the first execution result and the third comparison result indicates that the second execution result is inferior to the expected execution result, the first preset threshold to obtain a reduced first preset threshold, and using the reduced first preset threshold as the second preset threshold.

4. The method according to claim 3, comprising:
obtaining a target difference based on integrating, when a first difference corresponding to the second comparison result and a second difference corresponding to the third comparison result are obtained, the first difference with the second difference;
obtaining a threshold adjustment amount matching the target difference; and
the increasing the first preset threshold to obtain the increased first preset threshold comprises:
obtaining the increased first preset threshold based on increasing the first preset threshold with the threshold adjustment amount.

5. The method according to claim 1, wherein the obtaining the second hardware metric comprises:
adjusting a target configuration parameter of the device at the first moment based on the first comparison result, to adjust the first hardware metric to an adjusted hardware metric corresponding to an adjusted target configuration parameter at the first moment;
using the adjusted hardware metric as the second hardware metric of the device, the target configuration parameter being an execution configuration parameter set by the device in the virtual event, and the target configuration parameter being associated with the hardware metric; and
the adjusting the device at the second moment comprises:
adjusting a target configuration parameter of the device at the second moment by using the second preset threshold and the second hardware metric.

6. The method according to claim 5, wherein the adjusting the target configuration parameter comprises:
determining, when second process data of the virtual event at the second moment is obtained, an evaluated performance value at the second moment based on the second hardware metric and the second process data;
obtaining a fourth comparison results based on comparing the second preset threshold with the evaluated performance value at the second moment;
obtaining a third hardware metric of the device at a third moment based on adjusting the target configuration parameter of the device at the second moment with the fourth comparison result;
obtaining a fifth comparison based on comparing, when a third execution result of the virtual event at the third moment is obtained, the third execution result with the second execution;
obtaining a third preset threshold of the device at the third moment based on adjusting the second preset threshold with the fifth comparison result; and
adjusting a target configuration parameter of the device at the third moment by using the third preset threshold and the third hardware metric.

7. The method according to claim 1 comprising:
obtaining a first weight assigned to the first hardware metric and a second weight assigned to the process data; and
the determining an evaluated performance value comprises:
obtaining an evaluated hardware parameter based on calculating the first hardware metric with the first weight, and obtaining evaluated process data based on calculating the process data at the first moment with the second weight; and
obtaining the evaluated performance value based on integrating the evaluated hardware parameter with the evaluated process data.

8. The method according to claim 5, wherein the determining the evaluated performance value comprises:
determining an evaluated downgrading value of the device at the first moment and an evaluated upgrading value of the device at the first moment based on the first hardware metric and the process data; and
the first preset threshold comprises a preset downgrading threshold and a preset upgrading threshold, and the obtaining the second hardware metric comprises at least one of:
performing downgrading adjustment on the target configuration parameter of the device at the first moment when the first comparison result indicates that the evaluated downgrading value is greater than the preset downgrading threshold, to adjust the first hardware metric to an adjusted hardware metric corresponding to a target configuration parameter at the first moment obtained through the downgrading adjustment, and using the adjusted hardware metric as the second hardware metric; or
performing upgrading adjustment on the target configuration parameter of the device at the first moment when the first comparison result indicates that the evaluated upgrading value is less than the preset upgrading threshold, to adjust the first hardware metric to an adjusted hardware metric corresponding to a target configuration parameter at the first moment obtained through the upgrading adjustment, and using the adjusted hardware metric as the second hardware metric.

9. The method according to claim 1, wherein the obtaining the first hardware metric and the process data comprises:
obtaining the first hardware metric and virtual object data of a virtual game match at the first moment, the virtual game match being a round of a virtual game in which a virtual character participates under control of the device, and the virtual object data being virtual object data presented in the virtual game match; and
the obtaining the second comparison result comprises:
obtaining the second comparison result based on comparing, when a first game frame rate of the virtual game match at the first moment and a second game frame rate of the virtual event at the second moment are obtained, the first game frame rate with the second game frame rate, the second comparison result indicating a frame rate difference between the first game frame rate and the second game frame rate.

10. A device configuration adjustment apparatus comprising:
processing circuitry configured to:
obtain a first hardware metric of a device at a first moment that the device executes a virtual event;
obtain process data affecting performance of the device at the first moment;
determine, based on the first hardware metric and the process data, an evaluated performance value at the first moment that indicates a degree of matching between the performance of the device at the first moment and the virtual event;
obtain a first comparison result based on comparing a first preset threshold of the device with the evaluated performance value;
obtain a second hardware metric of the device at a second moment based on the first comparison result;
obtain a second comparison result based on comparing a first execution result of the virtual event at the first moment with a second execution result of the virtual event at the second moment;
obtain a second preset threshold of the device at the second moment based on adjusting the first preset threshold with the second comparison result; and
adjust the device at the second moment based on the second preset threshold and the second hardware metric.

11. The device configuration adjustment apparatus according to claim 10, wherein the processing circuitry is configured to:
obtain a third comparison result based on comparing, when an expected execution result of the virtual event is obtained, the second execution result with the expected execution result; and
obtain the second preset threshold based on adjusting the first preset threshold with the second comparison result and the third comparison result.

12. The device configuration adjustment apparatus according to claim 11, wherein the processing circuitry is configured to at least one of: increase, when the second comparison result indicates that the second execution result is superior to the first execution result and the third comparison result indicates that the second execution result is superior to the expected execution result, the first preset threshold to obtain an increased first preset threshold, and use the increased first preset threshold as the second preset threshold; or
increase reduce, when the second comparison result indicates that the second execution result is inferior to the first execution result and the third comparison result indicates that the second execution result is inferior to the expected execution result, the first preset threshold to obtain a reduced first preset threshold, and use the reduced first preset threshold as the second preset threshold.

13. The device configuration adjustment apparatus according to claim 12, wherein the processing circuitry is configured to:
obtain a target difference based on integrating, when a first difference corresponding to the second comparison result and a second difference corresponding to the third comparison result are obtained, the first difference with the second difference;
obtain a threshold adjustment amount matching the target difference; and
obtain the increased first preset threshold based on increasing the first preset threshold with the threshold adjustment amount.

14. The device configuration adjustment apparatus according to claim 10, wherein the processing circuitry configured:
adjust a target configuration parameter of the device at the first moment based on the first comparison result, to adjust the first hardware metric to an adjusted hardware metric corresponding to an adjusted target configuration parameter at the first moment;
use the adjusted hardware metric as the second hardware metric of the device, the target configuration parameter being an execution configuration parameter set by the device in the virtual event, and the target configuration parameter being associated with the hardware metric; and
adjust a target configuration parameter of the device at the second moment by using the second preset threshold and the second hardware metric.

15. The device configuration adjustment apparatus according to claim 14, wherein the processing circuitry is configured to:
determine, when second process data of the virtual event at the second moment is obtained, an evaluated performance value at the second moment based on the second hardware metric and the second process data;
obtain a fourth comparison results based on comparing the second preset threshold with the evaluated performance value at the second moment;
obtain a third hardware metric of the device at a third moment based on adjusting the target configuration parameter of the device at the second moment with the fourth comparison result;
obtain a fifth comparison based on comparing, when a third execution result of the virtual event at the third moment is obtained, the third execution result with the second execution;
obtain a third preset threshold of the device at the third moment based on adjusting the second preset threshold with the fifth comparison result; and
adjust a target configuration parameter of the device at the third moment by using the third preset threshold and the third hardware metric.

16. The device configuration adjustment apparatus according to claim 10, wherein the processing circuitry is configured to:
obtain a first weight assigned to the first hardware metric and a second weight assigned to the process data;
obtain an evaluated hardware parameter based on calculating the first hardware metric with the first weight;
obtain evaluated process data based on calculating the process data at the first moment with the second weight; and
obtain the evaluated performance value based on integrating the evaluated hardware parameter with the evaluated process data.

17. The device configuration adjustment apparatus according to claim 15, wherein the processing circuitry is configured to determine an evaluated downgrading value of the device at the first moment and an evaluated upgrading value of the device at the first moment based on the first hardware metric and the process data;
the first preset threshold comprises a preset downgrading threshold and a preset upgrading threshold;
the processing circuitry configured to at least one of:
perform downgrading adjustment on the target configuration parameter of the device at the first moment when the first comparison result indicates that the evaluated downgrading value is greater than the preset downgrading threshold, to adjust the first hardware metric to an adjusted hardware metric corresponding to a target configuration parameter at the first moment obtained through the downgrading adjustment, and use the adjusted hardware metric as the second hardware metric; or
perform upgrading adjustment on the target configuration parameter of the device at the first moment when the first comparison result indicates that the evaluated upgrading value is less than the preset upgrading threshold, to adjust the first hardware metric to an adjusted hardware metric corresponding to a target configuration parameter at the first moment obtained through the upgrading adjustment, and use the adjusted hardware metric as the second hardware metric.

18. A non-transitory computer-readable storage medium, storing instructions which when executed by a processor cause the processor to perform:
obtaining a first hardware metric of a device at a first moment that the device executes a virtual event;
obtaining process data affecting performance of the device at the first moment;
determining, based on the first hardware metric and the process data, an evaluated performance value at the first moment that indicates a degree of matching between the performance of the device at the first moment and the virtual event;
obtaining a first comparison result based on comparing a first preset threshold of the device with the evaluated performance value;
obtaining a second hardware metric of the device at a second moment based on the first comparison result;
obtaining a second comparison result based on comparing a first execution result of the virtual event at the first moment with a second execution result of the virtual event at the second moment;
obtaining a second preset threshold of the device at the second moment based on adjusting the first preset threshold with the second comparison result; and
adjusting the device at the second moment based on the second preset threshold and the second hardware metric.

19. The non-transitory computer-readable storage medium of claim 18, wherein the instructions when executed by the processor cause the processor to perform:
obtaining a third comparison result based on comparing, when an expected execution result of the virtual event is obtained, the second execution result with the expected execution result; and
the obtaining the second preset threshold comprises:
obtaining the second preset threshold based on adjusting the first preset threshold with the second comparison result and the third comparison result.

20. The non-transitory computer-readable storage medium of claim 19, wherein the obtaining the second preset threshold comprises at least one of:
increasing, when the second comparison result indicates that the second execution result is superior to the first execution result and the third comparison result indicates that the second execution result is superior to the expected execution result, the first preset threshold to obtain an increased first preset threshold, and using the increased first preset threshold as the second preset threshold; or
reducing, when the second comparison result indicates that the second execution result is inferior to the first execution result and the third comparison result indicates that the second execution result is inferior to the expected execution result, the first preset threshold to obtain a reduced first preset threshold, and using the reduced first preset threshold as the second preset threshold.
